(19) United States
(12) Patent Application Publication
(10) Pub. No.: US 2006/0087976 A1
(43) Pub. Date: Apr. 27, 2006

(54) Method and system for network analysis

(76) Inventors: David M. Rhodes, Loveland, CO (US); Srikanth Natarajan, Fort Collins, CO (US); Anthony Paul Michael Walker, Fort Collins, CO (US); Kam Chooi Wong, Fort Collins, CO (US); Darren D. Smith, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/972,027

(22) Filed: Oct. 22, 2004

(51) Int. Cl. H04J 3/14; H04L 12/28; H04L 12/403

(52) U.S. Cl. 370/242; 370/254; 370/449

(57) ABSTRACT

A method and system for analyzing a group of network elements in a network. One or more of the group of network elements, functionally coupled to provide a service, and a plurality of sub elements of the group of network elements are polled. A list having one or more items from one or more of the group of network elements and one or more of the sub elements is generated, wherein the one or more items have a changed state as determined by polling the one or more of the group of network elements and the plurality of sub elements of the group of network elements. The list is analyzed to perform one or more of setting a status for the group of network elements and reporting fault indications. A polling engine is operative to poll one or more of the group of network elements, and a plurality of sub elements of the group of network elements. A status analyzer is operative to generate the list comprising the one or more items and to analyze the list to perform one or more of: setting a status for the group of network elements and reporting fault indications.

### TECHNICAL FIELD

The present invention relates generally to communications networks and, more particularly, to a system and a method for network monitoring in a virtual service network.

### BACKGROUND

Modem communication networks are composed of many nodes that are interconnected to facilitate communication and provide redundancy. These nodes may be interconnected via cables, twisted pair, shared media or similar transmission media. Each node may comprise, for example, communication devices, interfaces, and addresses. The topology that describes how the nodes of a communication network are interconnected can be complicated. One of the complications is due to the use of virtual IP addressing, which allows communication with multiple devices having distinct physical addresses using a single virtual address. So, for example, if two routers are grouped together using a single virtual IP address and one of the routers becomes inoperative, the second router may be configured to receive the first router's communication traffic in a transparent manner. The use of virtual IP addressing is further illustrated with reference to FIG. 1. FIG. 1 shows an example 100 having two Hot Standby Routing Protocol (HSRP) groups where each group contains two nodes. Node 1 130 and node 2 140 may be communicated with using virtual IP 1.1.0.100 of HSRP group 1 110, while node 2 140 and node 3 150 in HSRP group 2 120 may communicate using virtual IP 1.1.0.101. One issue that arises when using groups of nodes that are represented using a virtual address as in the HSRP protocol is how to determine the status of the group and effectively handle situations in which one of the nodes in the group becomes inoperative.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a simple example of virtual IP addressing using two HSRP groups.

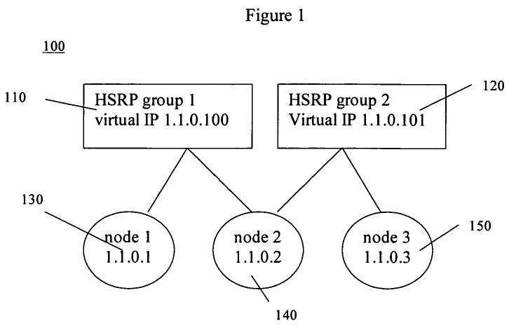

FIG. 2 is a polling system, according to certain embodiments of the present invention.

FIG. 3 is a simplified flowchart for a method of analyzing a group of nodes of a network, according to certain embodiments of the present invention.

FIG. 4 is a flowchart 400 illustrating how group status alarms are generated using a virtual service, according to certain embodiments of the present invention.

FIG. 5 is a simple flowchart for setting the group status of a HSRP group, according to certain embodiments of the present invention.

FIG. 6 is a detailed flowchart for setting the group status of a HSRP group, according to certain embodiments of the present invention.

FIG. 7 is a view of an HSRP browser, according to certain embodiments of the present invention.

FIG. 8 is a view of an HSRP browser when a fail over occurs, according to certain embodiments of the present invention.

FIG. 9 is a view of a status alarm browser after the fail occurs, according to certain embodiments of the present invention.

FIG. 10 is a view of a HSRP browser that has gone back to normal, according to certain embodiments of the present invention.

FIG. 11 is a view of a HSRP browser when a router becomes unreachable, according to certain embodiments of the present invention.

FIG. 12 is a view of a status alarm browser when the router becomes unreachable, according to certain embodiments of the present invention.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

A network element is defined to be one of a node, interface, address, connection or transmission media. A subelement is an element that is part of a larger element; for example an interface coupled to a node. It is noted that a group of network elements may be formed to provide a service to the network or to users of the network. The network elements in the group are not required to be homogeneous. One service that may be provided by the group of network elements is a virtual service. A virtual service network is a network in which virtual addressing is used so that one or more nodes of the network may be transparently accessed. That is a user of the network interacts with the one or more network elements without having to be concerned with details of how the network elements are individually addressed. One example of a group of network elements having a virtual service is the Hot Standby Routing Protocol (HSRP) that uses virtual IP addressing.

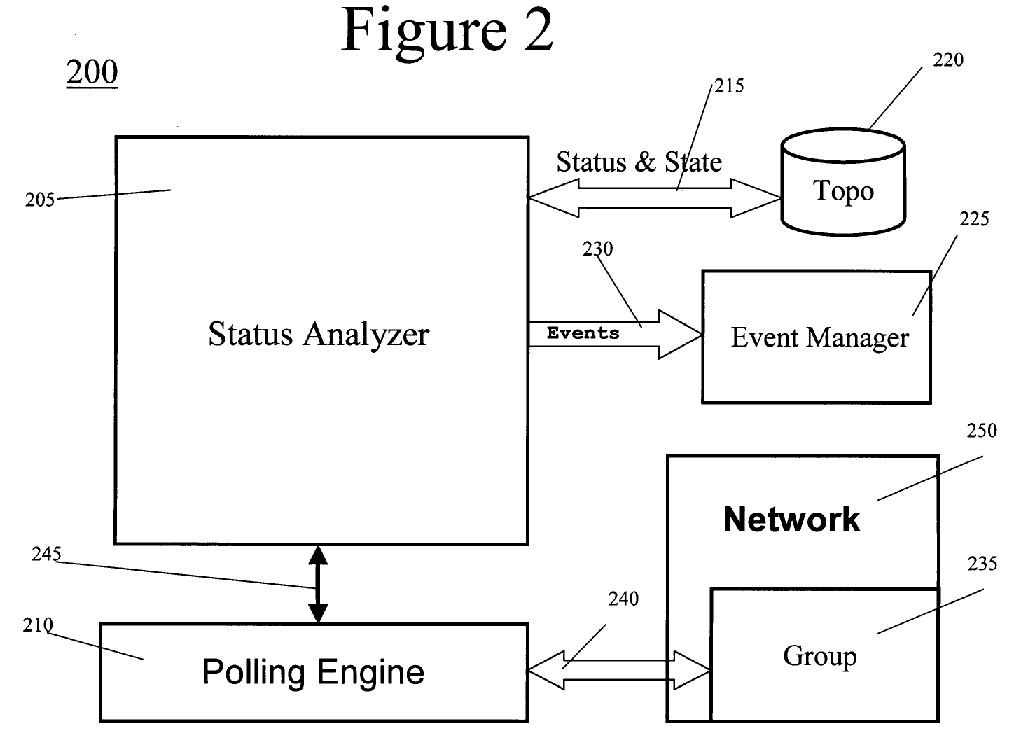

Referring now to FIG. 2, a polling system 200 is shown, according to certain embodiments of the present invention. The polling system comprises polling engine 210 that is coupled to status analyzer 205 and a group of network elements 235 of network 250. In certain embodiments of the present invention polling engine 210 is operative to poll 240 one or more of the group 235 and a plurality of sub elements of the group of network elements. The network elements are functionally coupled to provide a service. In certain embodiments the polling engine 210 uses a network management query such as found in the Simple Network Management Protocol (SNMP). The status analyzer 205 receives polling information from the polling engine 210, and status and state information 215 from a topology manager 220.

In certain embodiments of the present invention, the status analyzer 205 is operable to generate a list comprising one or more items from one or more of the group of network elements and one or more of the plurality of sub elements. Each of the one or more items has a changed state as determined by the poll of the one or more of the group 235 and the plurality of sub elements of the group 235. In certain embodiments the topology manager 220 is operable to update a network topology using the list. Items in the list having a transient state may be repolled after a configurable delay in certain embodiments of the invention.

The changed state may be determined from the polling engine 210 polling the group 235. In certain embodiments, polling engine 210 polls the plurality of sub elements of the group 235. In certain embodiments, the change in state is one of transitional, operational, degraded and inoperational. The status analyzer 205 is further operative to analyze the list to set a status for the group of network elements or report fault indications. In certain embodiments of the present invention, the fault indications are reported to an event manager 225. Event manager 225 may then emit or actuate alarms based upon these fault indications.

The information obtained by the polling engine 210 that is provided to status analyzer 205 for the purpose of populating the list may be categorized as one of status information, group responsibility information, and network coupling information. Status information is defined as information specific to the network element that is polled. This could be, for example, the communication state of the network element, an identifier of the network element, or device specific information. The group responsibility information is that information related to the role of the network element relative to the service provided by the group 235. The group responsibility information could be, for example, the group state of the network element or a priority of the network element. The network coupling information indicates how the network element is coupled to the network 250. This network coupling information could include, for example, how the network element communicates with the network or whether the network element is part of a second group.

The fault indications mentioned previously may be reported in certain embodiments when one of the following occurs:
if more than one item from the list is in an active state, the status analyzer 205 sets the status for the group of network elements to MAJOR and the event manager 225 generates a first alarm;
if more than one item from the list is in a standby state, the status analyzer 205 sets the status for the group of network elements to MAJOR and the event manager 225 generates a second alarm;
if none of the items in the list are in a listen state, the status analyzer 205 sets the status for the group of network elements to WARNING, and the event manager 225 generates a third alarm;
if none of the items in the list are in an active state, the status analyzer 205 sets the status for the group of network elements to CRITICAL and the event manager 225 generates a fourth alarm;
if none of the items in the list are in a standby state, the status analyzer 205sets the status for the group of network elements to MARGINAL and the event manager 225 generates a fifth alarm;
if an active state of an item in the list is transferred to a different item in the list then the event manager 225 generates a sixth alarm; and
if a standby state of an item in the list is transferred to a different item in the list, then the event manager 225 generates a seventh alarm.

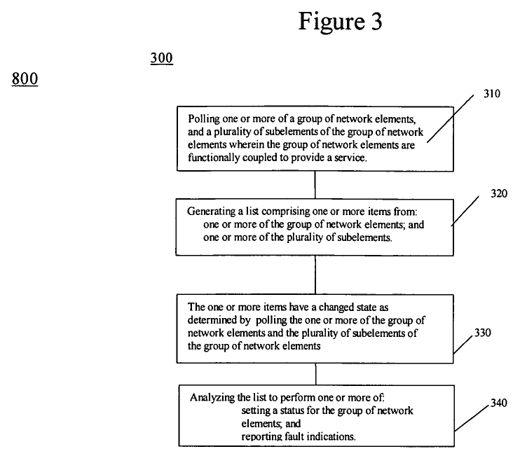

With reference to FIG. 3, a simplified flowchart for a method of analyzing a group of nodes of a network is shown, according to certain embodiments of the present invention. At block 310 the method comprises polling one or more of the group 235 of network elements, and a plurality of sub elements of the group 235. The group 235 of network elements are functionally coupled to provide a service. At block 320, the method comprises generating a list comprising one or more items from one or more of the group of network elements, and one or more of the plurality of sub elements.

The one or more items have a changed state as determined by polling the one or more of the group of network elements and the plurality of sub elements of the group of network elements at block 330. At block 340, the list is analyzed thereby performing one or more of: setting a status for the group of network elements, and reporting fault indications. In certain embodiments of the present invention, the status for the group 235 is one of NORMAL, CRITICAL, WARNING, MARGINAL, MAJOR, and UNKNOWN. The fault indications are as stated previously.

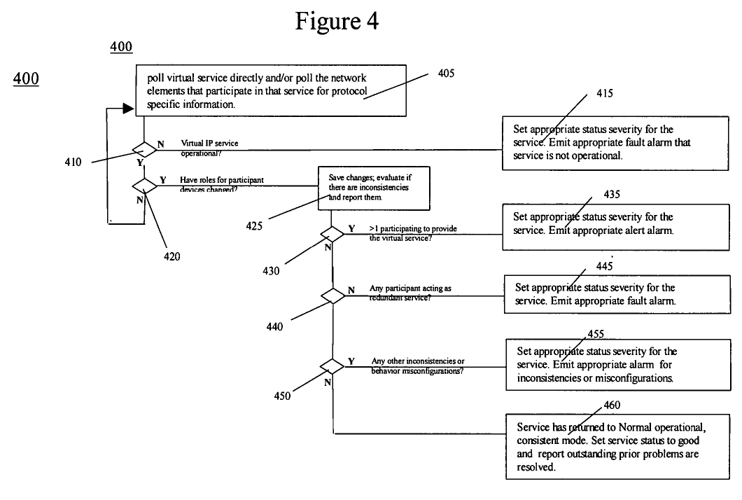

In certain embodiments of the present invention, the service provided by the group 235 may be a virtual service, such as virtual IP addressing. The polling engine 210 polls the virtual service and analyzer 205 sets an appropriate status and event manager 225 reports fault indications as shown in FIG. 2. When the service is a virtual service, additional events are of interest, including when the virtual service is not operational, more than one network element is providing the virtual service, no network element in the group of networks is providing a backup for the virtual service, and when a network element is configured incorrectly. One example of an implementation of a virtual service occurs when the group 235 is an HSRP group. The embodiment using the virtual service may be summarized with reference to FIG. 4.

Referring to FIG. 4, a flowchart 400 illustrating how group status alarms are generated using a virtual service is shown, according to certain embodiments of the present invention. At block 405, the virtual service may be polled directly or the network elements that participate in the virtual service may be polled for protocol specific information. It is noted that the network elements may be physical nodes or be considered one or more network elements or sub elements. If the virtual service is operational (Y at block 410) and the behavior of any network element in the group has not changed (N at block 420), then no alarms or events are generated.

If the virtual service is not operational, then an appropriate status and fault alarm is generated (block 415). In certain embodiments the status is CRITICAL and a NO_ACTIVE_INTERFACE is generated. If the behavior of any network elements of the group has changed (YES at block 420), then the changes are saved and any inconsistencies are reported (block 425). In certain embodiments, the inconsistencies are saved and/or updated to a topology manager 220. If more than one network element is providing the service (YES at block 430), then the appropriate status is set and an alarm generated (block 435). In certain embodiments of the present invention, the status is set to MAJOR and an MULTIPLE_ACTIVE_INTERFACE is generated.

If there is not any network element that is providing the virtual service (N block 440), then the appropriate status is set and an alarm generated (block 445). In certain embodiments of the present invention, the status is set to CRITICAL and an NO_ACTIVE_INTERFACE alarm is generated. Any other inconsistencies or behavior problems (YES at block 450) may be handled in a similar manner with a status and alarm being generated. It is noted that the behavior may be determined by a change in status, a changed group interaction, or a change in network coupling. In certain embodiments, changes in network element behavior are reported to analyzer 205. Otherwise, if there are no inconsistencies or behavior problems (N at block 450), the virtual service status is set to NORMAL and a normal alarm is generated (block 460). In certain embodiments the alarms generated are one of:

NO_ACTIVE_INTERFACE;

MULTIPLE_ACTIVE_INTERFACE;

NO_STANDBY_INTERFACE;

GROUP_DEGRADED;

FAIL_OVER;

STANDBY_CHANGED;

NORMAL; and

MULTIPLE_STANDBY_INTERFACE.

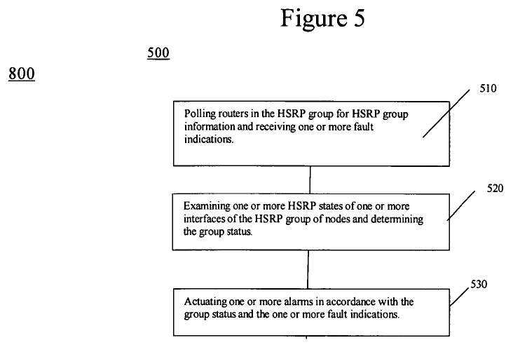

In certain embodiments of the present invention, the HSRP protocol is employed to provide virtual IP addressing of a group of nodes. Referring to FIG. 5, a simplified flowchart 500 for setting the HSRP status is shown, according to certain embodiments of the present invention. At block 510, nodes of the HSRP group 235 are polled for group information and the polling engine 210 receives one or more fault indications. The poll of the nodes uses a network management query such as found in SNMP. At block 520, the HSRP group status is determined by examining one or more HSRP states of interfaces of the HSRP group 235. Block 530 actuates one or more alarms in accordance with the group status and the one or more fault indications. In certain embodiments if an interface of the HSRP group 235 is in a transient state, the polling engine 210 polls the interface after a configurable time interval. The HSRP group information provides detail on how the HSRP group is configured and in certain embodiments this HSRP group information includes HSRP state and HSRP priority. Changes in HSRP group information are operable to update the topology manager 220. The HSRP state is one of: initial, learn, listen, speak, standby, and active. Many settings of the group status and alarms generated are possible depending on the value of the HSRP state. The status analyzer 205 is operable to determine the group status and actuate the alarms. For example:
if more than one HSRP interface is in the active state, then setting the group status to MAJOR and generating a MULTIPLE_ACTIVE_INTERFACE alarm;
if more than one HSRP interface is in the standby state, then setting the group status to MAJOR and generating a MULTIPLE_STANDBY_INTERFACE alarm;
if there are more than two HSRP interfaces in the plurality of interfaces and none of these interfaces are in the listen state, setting the status for the group of nodes to WARNING, and generating a GROUP_DEGRADED alarm;
if no HSRP interface is in the active state, then setting the group status to CRITICAL and generating a NO_ACTIVE_INTERFACE alarm;
if no HSRP interface is in the standby state, then setting the group status to MARGINAL and generating a NO_STANDBY_INTERFACE alarm;
if an active interface of the plurality of interfaces is not the previous active interface, generating a FAIL_OVER alarm; and
if a standby interface of the plurality of interfaces is not the previous standby interface, generating a STANDBY_CHANGED alarm.

It is noted that in certain embodiments, if at least one of the MULTIPLE_ACTIVE_INTERFACE alarm, the MULTIPLE_STANDBY_INTERFACE alarm, the GROUP_DEGRADED alarm, NO_ACTIVE_INTERFACE alarm, and the NO_STANDBY_INTERFACE alarm is generated, then the FAIL_OVER alarm and the STANDBY_CHANGED alarm are not generated. In certain embodiments the group status is one of:

NORMAL;

CRITICAL;

WARNING;

MARGINAL;

MAJOR; and

UNKNOWN.

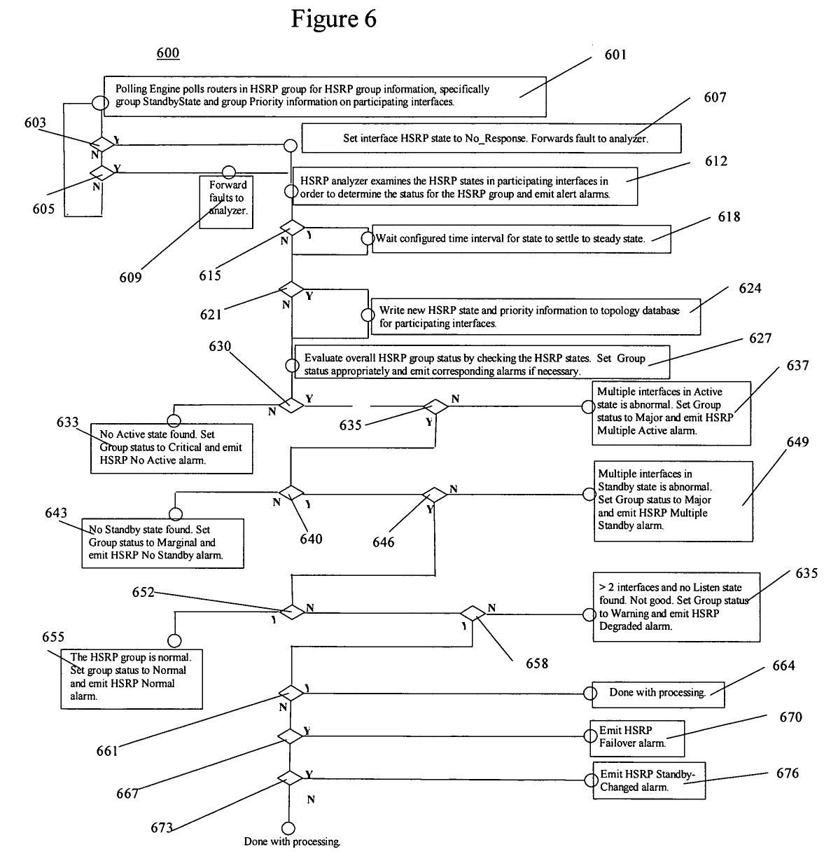

Referring now to FIG. 6, a detailed flowchart for setting the HSRP group status is shown, according to certain embodiments of the present invention. At block 601, the polling engine 210 polls routers in an HSRP group for group information, specifically group standbyState and group priority information on participating interfaces. If NO at decision block 603 (Active router returns timeout?) and NO at decision block 605 (Other faults found?), the polling engine 210 continues to poll. If YES at decision block 603 (Active router returns timeout?), at block 607, the interface HSRP state is set to No_Response and the fault is forwarded to the analyzer. If YES at decision block 603 (Active router returns timeout?), and if YES at decision block 605 (Other faults found?), then the faults are forwarded to analyzer at block 609. At block 612, the HSRP analyzer examines the HSRP states in participating interfaces in order to determine the status for the HSRP group and actuates or emits alert alarms.

After block 607 or block 612, if YES at decision block 615 (One or more participating interfaces has a transient HSRP state?), at block 618, we wait a configured time interval for the state to settle to steady state and re-poll any interface if it is still in transient state. After block 618 or if NO at decision block 615 (One or more participating interface has a transient HSRP state?), then decision block 621 is evaluated. If YES at decision block 621 (One or more participating interface HSRP state or Group Priority has changed?), at block 624, a new HSRP state and priority information is written to topology database for participating interfaces and the flow continues to block 627 If the decision at decision block 621 is NO, then the flow continues directly to block 627. At block 627, we evaluate the overall HSRP group status by checking the HSRP states. The appropriate group status is set and corresponding alarms actuated if necessary.

If NO at decision block 630 (Participating interface in HSRP Active state?), at block 633 there is no Active state found. The group status is set to Critical and HSRP No Active alarm is actuated.

If YES at decision block 630 (Participating interface in HSRP Active state?) and NO in decision block 635 (Found just one?), at block 637, multiple interfaces found in an Active state is abnormal. The group status is set to Major and HSRP Multiple Active alarm is actuated.

If YES in decision block 630 (Participating interface in HSRP Active state?), YES in decision block 635 (Found just one?), and NO in decision block 640 (Participating interface in HSRP Standby state?), then at block 643, there is no Standby state found the group status is set to Marginal and the HSRP No Standby alarm is actuated. If YES at decision block 640 (Participating interface in HSRP Standby state?) and NO at decision block 646 (Found just one?), at block 649, the multiple interfaces in Standby state are abnormal. The group status is set to Major and the HSRP Multiple Standby alarm is actuated.

If the decision is Yes at decision block 646, then the flow continues to decision block 652. If YES at decision block 652 (Participating interface in HSRP Listen state?), at block 655, the HSRP group is normal. The group status is set to Normal and the HSRP Normal alarm is actuated. If NO at decision block 652 (Participating interface in HSRP Listen state?) and NO at decision block 658 (Only 2 interfaces, 1 Active, 1 Standby?), at block 635, there are more than two interfaces and no Listen state found. The group status is set to Warning and the HSRP Degraded alarm is actuated. If YES at decision block 658, then the flow continues to decision block 661. If YES at decision block 661 (any fault/alert alarm actuated?), then at block 664, we are done with processing. Otherwise, a NO at decision block 661 causes the flow to proceed to decision block 667. If YES at decision block 667 (Active Interface not the same one as before?), block 670 actuates the HSRP fail over alarm. If NO at decision block 667, then proceed to decision block 673. If YES at decision block 673 (Standby Interface not the same one as before?), at block 676, HSRP standby_changed alarm is actuated. If NO at decision block 673, then we are done with processing.

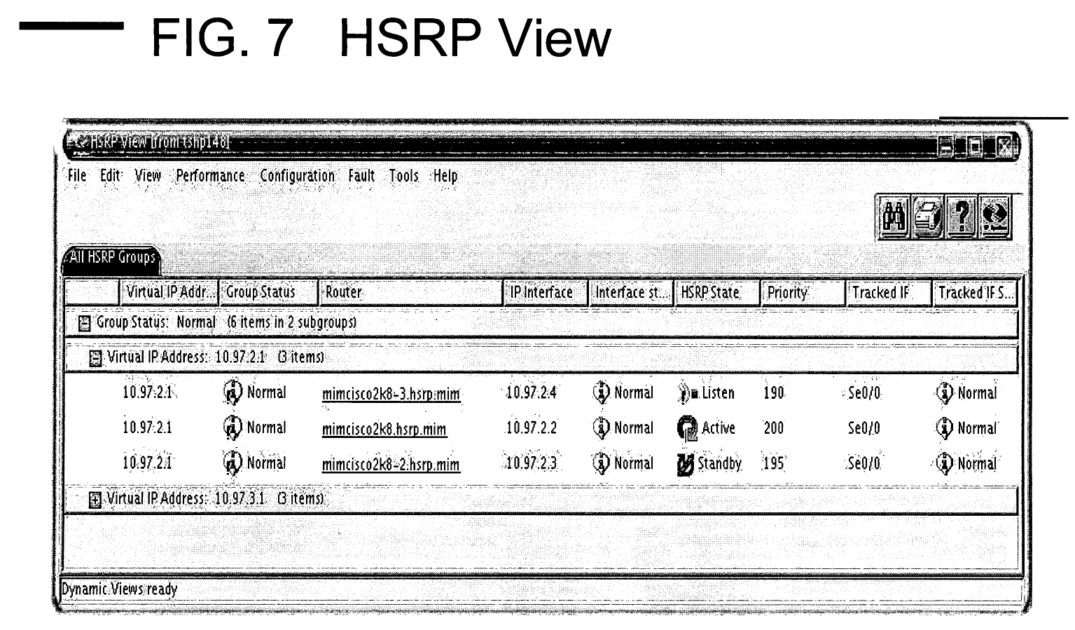

An example of a use of an embodiment of the method and system of the present invention is given in FIGS. 7-12. Referring now to FIG. 7, a view of an HSRP browser is shown, according to certain embodiments of the present invention. It shows two HSRP groups identified by their virtual IP address with a Normal group status where the first group is expanded to display the three interfaces with their corresponding HSRP states of Listen, Active and Standby.

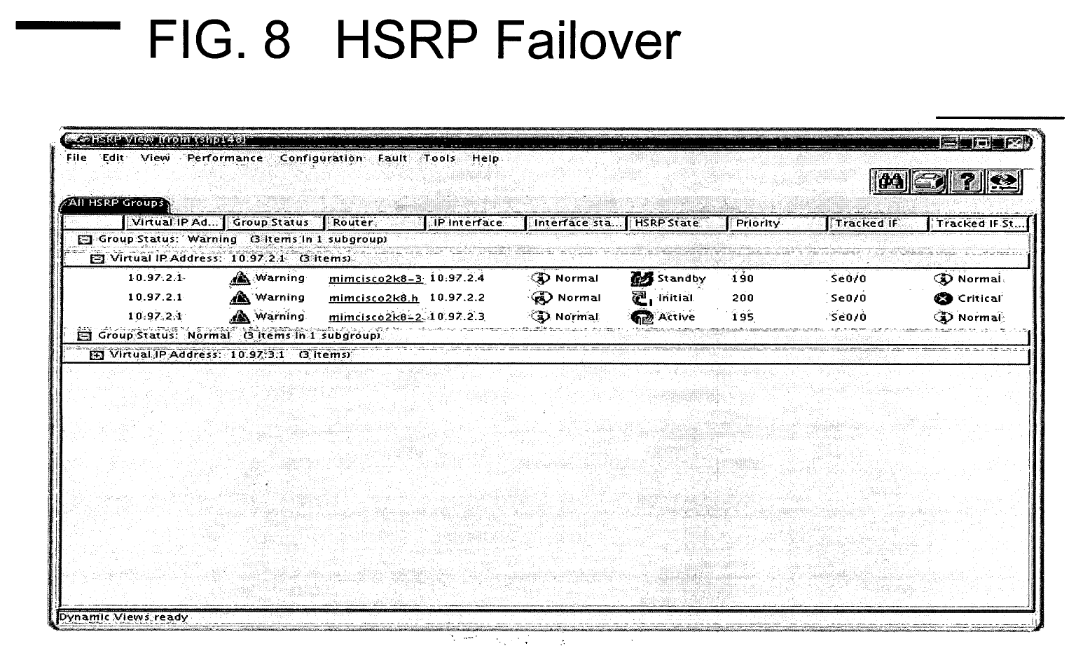

Referring now to FIG. 8, a view of an HSRP browser when a fail over occurs is shown, according to certain embodiments of the present invention. It shows the group status of the aforementioned group changed to Warning from Normal and the Active state of the interface changed to the Initial state.

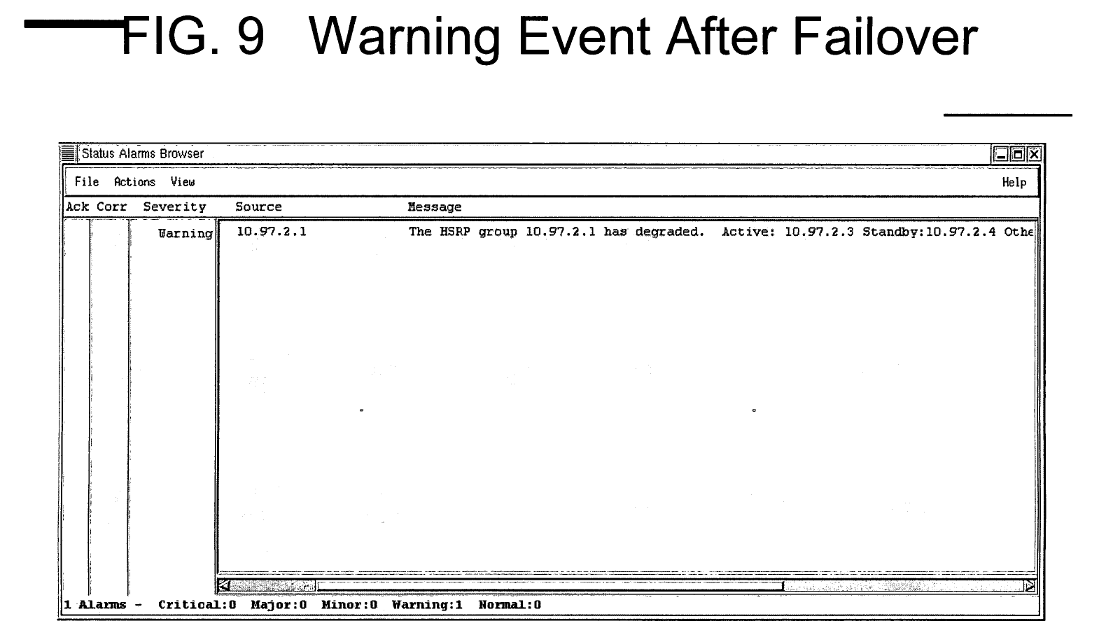

Referring now to FIG. 9, a view of a status alarm browser after the aforementioned failover occurs is shown, according to certain embodiments of the present invention. The corresponding HSRP degraded alarm is actuated and displayed for that group.

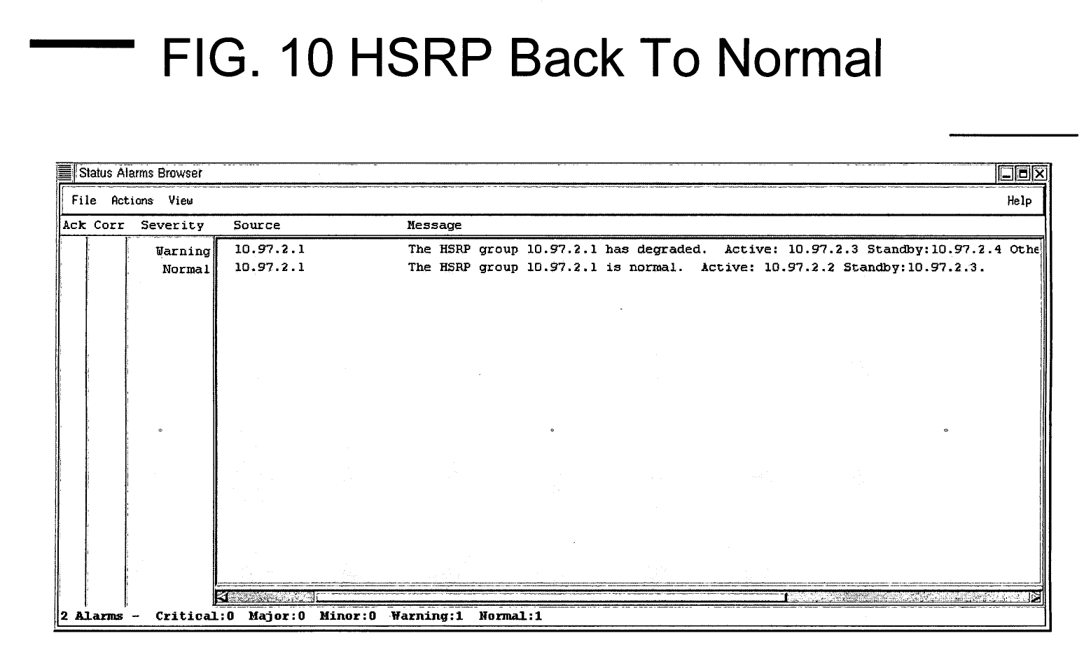

Referring now to FIG. 10, a view of a status alarm browser for the aforementioned HSRP group which has gone back to normal is shown, according to certain embodiments of the present invention. It shows a HSRP Normal alarm emitted (actuated) and displayed for that group.

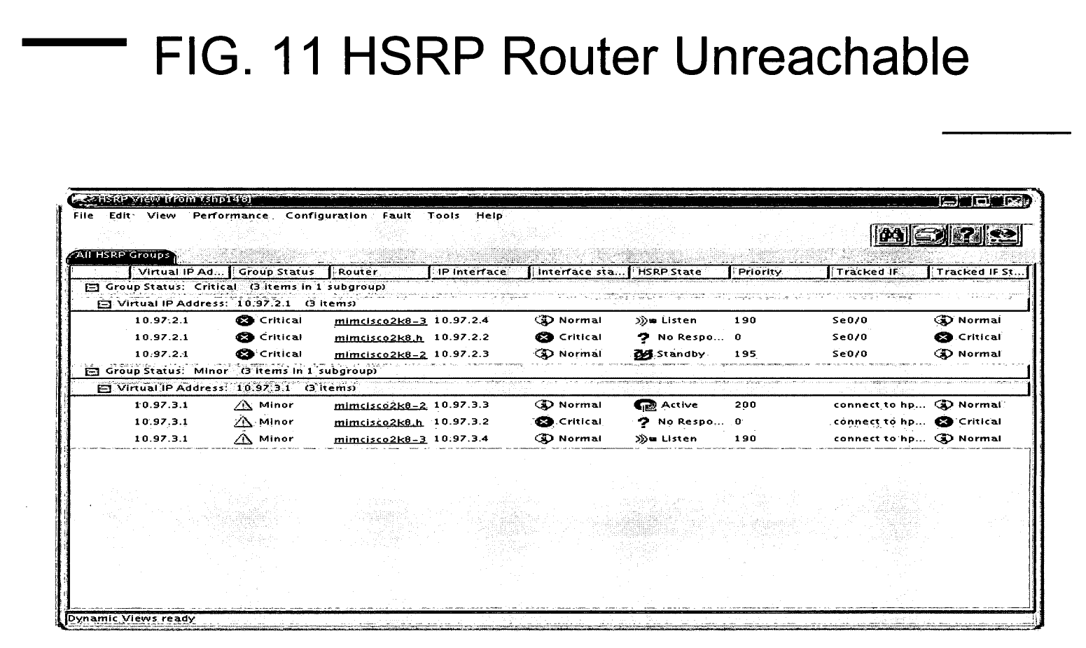

Referring now to FIG. 11, a view of a HSRP browser when a router becomes unreachable is shown, according to certain embodiments of the present invention. It shows the HSRP group status changed to Critical because the active router is not responding, which is indicated by the No Response HSRP state for the Active interface.

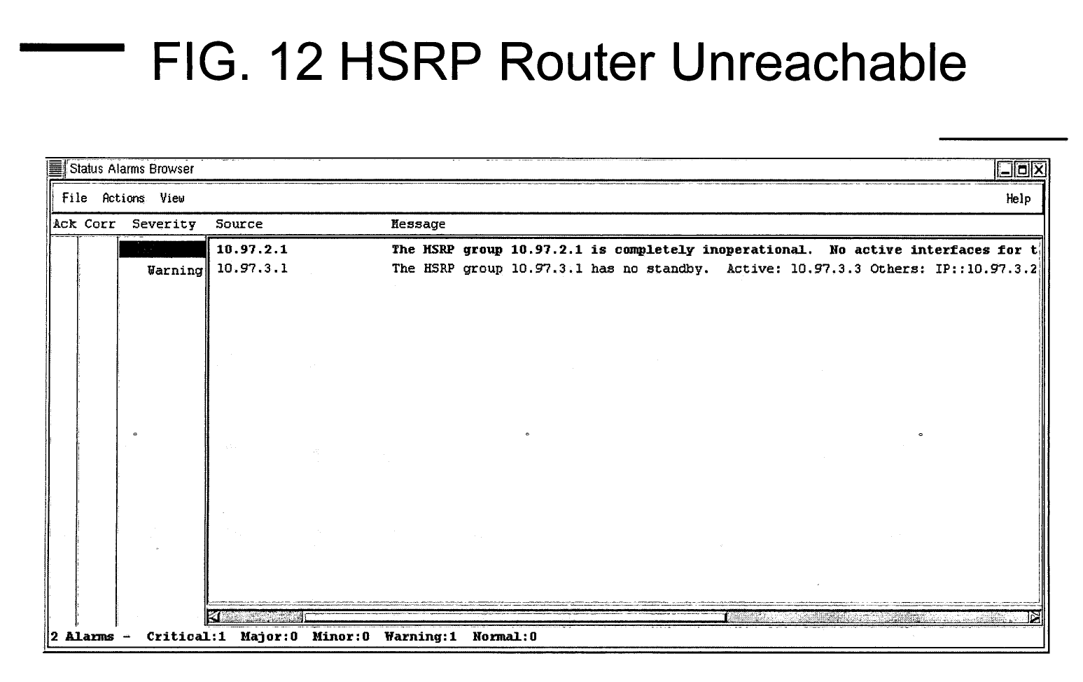

Referring now to FIG. 12 a view of a status alarm browser when the aforementioned router becomes unreachable is shown, according to certain embodiments of the present invention. The corresponding fault alarm that the HSRP group is inoperational is emitted (actuated) and displayed.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method of analyzing a group of network elements, comprising:
polling one or more of:
the group of network elements, and
a plurality of sub elements of the group of network elements,
wherein the group of network elements are functionally coupled to provide a service;
generating a list comprising one or more items from:
one or more of the group of network elements, and
one or more of the plurality of sub elements,
wherein the one or more items have a changed state as determined by polling the one or more of the group of network elements and the plurality of sub elements of the group of network elements; and
analyzing the list to perform one or more of:
setting a status for the group of network elements; and
reporting fault indications.

2. The method of claim 1, wherein information obtained by polling comprises one or more of: status information, group interaction information and network coupling information.

3. The method of claim 1, wherein a change in a state is one of the following:
transitional;
operational;
degraded; and
inoperational.

4. The method of claim 1, wherein reporting fault indications further comprises one or more of the following:
if more than one item from the list is in an first state, setting the status for the group of network elements to MAJOR and generating a first alarm;
if more than one item from the list is in a second state, setting the status for the group of network elements to MAJOR and generating a second alarm;
if none of the items in the list are in a third state, setting the status for the group of network elements to WARNING, and generating a third alarm;
if none of the items in the list are in an fourth state, setting the status for the group of network elements to CRITICAL and generating a fourth alarm;
if none of the items in the list are in a fifth state, setting the status for the group of network elements to MARGINAL and generating a fifth alarm;
if a sixth state of an item in the list is transferred to a different item in the list, generating a sixth alarm; and
if a seventh state of an item in the list is transferred to a different item in the list, generating a seventh alarm.

5. The method of claim 1, wherein the status for the group of network elements is one of:
NORMAL;
CRITICAL;
WARNING;
MARGINAL;
MAJOR; and
UNKNOWN.

6. The method of claim 1, further comprising updating a network topology using the list.

7. The method of claim 1, wherein polling uses a network management query.

8. The method of claim 1, further comprising determining if a state of one of a network element and subelement has changed by comparing the state to a stored state in a network topology.

9. The method of claim 1, wherein the group of network elements is an HSRP group.

10. A system to analyze a group of network elements of a network wherein the group of network elements has a plurality of interfaces with each interface having an interface state, comprising:
a polling engine operative to poll one or more of
the group of network elements, and
a plurality of sub elements of the group of network elements,
wherein the network elements are functionally coupled to provide a service;
a status analyzer operative to generate a list comprising one or more items from:
one or more of the group of network elements, and
one or more of the plurality of sub elements,
wherein the one or more items have a changed state as determined by the poll of the one or more of the group of network elements and the plurality of sub elements of the group of network elements;
the status analyzer operative to analyze the list to perform one or more of:
set a status for the group of network elements; and
report fault indications.

11. The system of claim 10, wherein information obtained by polling engine comprises one or more of: status information, group responsibility information and network coupling information.

12. The system of claim 10, wherein a changed state is one of:
transitional;
operational;
degraded; and
inoperational.

13. The system of claim 10, wherein report fault indications further comprises one or more of the following:
if more than one item from the list is in an active state, the status analyzer sets the status for the group of network elements to MAJOR and an event manager generates a first alarm;
if more than one item from the list is in a standby state, the status analyzer sets the status for the group of network elements to MAJOR and the event manager generates a second alarm;
if none of the items in the list are in a listen state, the status analyzer sets the status for the group of network elements to WARNING, and the event manager generates a third alarm;
if none of the items in the list are in an active state, the status analyzer sets the status for the group of network elements to CRITICAL and the event manager generates a fourth alarm;
if none of the items in the list are in a standby state, the status analyzer sets the status for the group of network elements to MARGINAL and the event manager generates a fifth alarm;
if an active state of an item in the list is transferred to a different item in the list, the event manager generates a sixth alarm; and
if a standby state of an item in the list is transferred to a different item in the list, the event manager generates a seventh alarm.

14. The system of claim 10, wherein the status for the group of network elements is one of:
NORMAL;
CRITICAL;
WARNING;
MARGINAL;
MAJOR; and
UNKNOWN.

15. The system of claim 10, further comprises a topology manager operable to update a network topology using the list.

16. The system of claim 10, wherein the polling engine uses a network manager query.

17. The system of claim 10, wherein the group of network elements is an HSRP group.

18. The system of claim 10, wherein if an item on the list is in a transient state, the polling engine re-polls the item.

19. A method of determining a status of a virtual service provided by a group of network elements in a network, comprising:
polling one or more of:
the virtual service;
one or more elements of the group of network elements;
performing one or more of setting an appropriate status of the virtual service and reporting fault indications for one or more of the following events:
the virtual service is not operational;
one or more of the network elements in the group of network elements has a changed behavior;
more than one of the network elements in the group of network elements are providing the virtual service;
no network element in the group of network elements is a backup for the virtual service; and
any network element in the group of network elements is configured incorrectly.

20. The method of claim 19, wherein the virtual service uses virtual IP addressing.

21. The method of claim 19, wherein the polling uses a network management query.

22. The method of claim 19, further comprising reporting to a network analyzer if one or more of the network elements in the group of network elements has one or more of:
a changed status;
a changed group interaction; and
a changed network coupling.

23. The method of claim 19, wherein the group of network elements is an HSRP group.

24. A system operable to determine a status of a virtual service provided by a group of network elements in a network, comprising:
a polling engine operable to poll one or more of:
the virtual service;
one or more elements of the group of network elements;
an analyzer operable to set an appropriate status and an event manager operable to report fault indications for one or more of the following:
the virtual service is not operational;
one or more of the network elements in the group of network elements has a changed behavior;
more than one of the network elements in the group of network elements are providing the virtual service;
no network element in the group of network elements is a backup for the virtual service; and
any network element in the group of network elements is configured incorrectly.

25. The system of claim 24, wherein the virtual service uses virtual IP addressing.

26. The system of claim 24, wherein the polling engine poll uses a network management query.

27. The system of claim 24, further comprising the polling engine reports to the analyzer if one or more of the network elements in the group of network elements has one or more of:
a changed status;
a changed group interaction; and
a changed network coupling.

28. The system of claim 24, wherein the group of network elements is an HSRP group.

29. A method of assigning a group status to an HSRP group, comprising:
polling routers in the HSRP group for HSRP group information and receiving one or more fault indications;
examining one or more HSRP states of one or more interfaces of the HSRP group of nodes and determining the group status; and
actuating one or more alarms in accordance with the group status and the one or more fault indications.

30. The method of claim 29, wherein if one or more interfaces of the HSRP group is in a transient state, polling the one or more interfaces after a configurable time interval.

31. The method of claim 29, wherein the HSRP group information comprises one or more of HSRP state and HSRP group priority, wherein the HSRP state is one of:
initial;
learn;
listen;
speak;
standby; and
active.

32. The method of claim 31, further comprising one or more of the following:
if more than one HSRP interface is in the active state, then setting the group status to MAJOR and generating a MULTIPLE_ACTIVE_INTERFACE alarm;
if more than one HSRP interface is in the standby state, then setting the group status to MAJOR and generating a MULTIPLE_STANDBY_INTERFACE alarm;
if there are more than two HSRP interfaces in the plurality of interfaces and none of these interfaces are in the listen state, setting the status for the group of nodes to WARNING, and generating a GROUP_DEGRADED alarm;
if no HSRP interface is in the active state, then setting the group status to CRITICAL and generating a NO_ACTIVE_INTERFACE alarm;
if no HSRP interface is in the standby state, then setting the group status to MARGINAL and generating a NO_STANDBY_INTERFACE alarm;
if an active interface of the plurality of interfaces is not a previous active interface, generating a FAIL_OVER alarm; and
if a standby interface of the plurality of interfaces is not a previous standby interface, generating a STANDBY_CHANGED alarm.

33. The method of claim 32, The method of claim 1, wherein if at least one of the MULTIPLE_ACTIVE_INTERFACE alarm, the MULTIPLE_STANDBY_INTERFACE alarm, the GROUP_DEGRADED alarm, NO_ACTIVE_INTERFACE alarm, and the NO_STANDBY_INTERFACE alarm is generated, then the FAIL_OVER alarm and the STANDBY_CHANGED alarm are not generated.

34. The method of claim 31, wherein if the HSRP state or HSRP group priority information changes further comprising updating a topology database.

35. The method of claim 31, wherein polling the group of nodes uses an SNMP query.

36. The method of claim 29, wherein the group status is one of:
NORMAL;
CRITICAL;
WARNING;
MARGINAL;
MAJOR; and
UNKNOWN.

37. The method of claim 29, wherein the alarms are one or more of:
NO_ACTIVE_INTERFACE;
MULTIPLE_ACTIVE_INTERFACE;
NO_STANDBY_INTERFACE;
GROUP_DEGRADED;
FAIL_OVER;
STANDBY_CHANGED;
NORMAL; and
MULTIPLE_STANDBY_INTERFACE.

38. A system that assigns a group status to an HSRP group, comprising:
a polling engine that polls routers in the HSRP group for HSRP group information and receives one or more fault indications; and
a status analyzer that receives the one or more fault indications from polling engine;
wherein the status analyzer examines HSRP states of one or more interfaces of the HSRP group and determines the group status and wherein the status analyzer actuates one or more alarms corresponding with group status and the one or more fault indications.

39. The system of claim 38, wherein if one or more interfaces of the HSRP group is in a transient state, the status analyzer directs the polling engine to poll the one or more interfaces after a configurable time interval.

40. The system of claim 38, wherein the HSRP group information comprises one or more of HSRP state and HSRP group priority, wherein the HSRP state is one of:
initial;
learn;
listen;
speak;
standby; and
active.

41. The system of claim 40, further comprising an event manager operatively coupled to the status analyzer and further comprising one or more of the following:
if more than one HSRP interface is in the active state, then the group status is set to MAJOR by the status analyzer and a MULTIPLE_ACTIVE_INTERFACE alarm is generated by the event manager;
if more than one HSRP interface is in the standby state, then the group status is set to MAJOR by the status analyzer and a MULTIPLE_STANDBY_INTERFACE alarm is generated by the event manager;
if there are more than two HSRP interfaces and none of these HSRP interfaces are in the listen state, the status for the group of nodes is set to WARNING by the status analyzer, and a GROUP_DEGRADED alarm is generated by the event manager;
if no HSRP interface is in the active state, then the group status is set to CRITICAL by the status analyzer and a NO_ACTIVE_INTERFACE alarm is generated by the event manager;
if no HSRP interface is in the standby state, then the group status is set to MARGINAL by the status analyzer and a NO_STANDBY_INTERFACE is generated by the event manager;
if an active interface of the plurality of interfaces is not a previous active interface, generating a FAIL_OVER alarm; and
if a standby interface of the plurality of interfaces is not a previous standby interface, generating a STANDBY_CHANGED alarm.

42. The system of claim 38, wherein if the HSRP state or HSRP group priority information changes the status analyzer updates a topology database.

43. The system of claim 38, wherein the polling engine polls the routers of the HSRP group using an SNMP query.

44. The system of claim 38, wherein the group status is one of:
NORMAL;
CRITICAL;
WARNING;
MARGINAL;
MAJOR; and
UNKNOWN.

45. The system of claim 38, wherein the alarms are one or more of:
NO_ACTIVE_INTERFACE;
MULTIPLE_ACTIVE_INTERFACE;
NO_STANDBY_INTERFACE;
GROUP_DEGRADED;
FAIL_OVER;
STANDBY_CHANGED;
NORMAL; and
MULTIPLE_STANDBY_INTERFACE.

46. A system to analyze a group of network elements of a network, comprising:
means for polling one or more elements of the group of network elements, wherein said group of network elements are functionally coupled to provide a service;
means for determining if one of more items of the group of network elements have changed state, wherein a changed state is determined by the polling of the one or more elements of the group of network elements and comparing a current polled state an element to a previous polled state of the element; and
means for analyzing the one or more items wherein a result of said analysis is operable to set a status for the group of network elements and report fault indications.
